(19) United States
(12) Patent Application Publication
(10) Pub. No.: US 2019/0251759 A1
(43) Pub. Date: Aug. 15, 2019

(54) VEHICLE DATA AGGREGATION AND ANALYSIS PLATFORM PROVIDING DEALERSHIP SERVICE PROVIDER DASHBOARD

(71) Applicant: The Car Force Inc., Houston, TX (US)

(72) Inventors: Jessika Fania LORA, San Francisco, CA (US); Mohammed Zeashan PAPPA, Raleigh, NC (US)

(21) Appl. No.: 16/313,602

(22) PCT Filed: Jun. 29, 2017
(86) PCT No.: PCT/US2017/040059

§ 371 Date: Dec. 27, 2018

Related U.S. Application Data
(60) Provisional application No. 62/357,286, filed on Jun. 30, 2016.

(51) Int. Cl. G07C 5/00; G07C 5/08; G06Q 10/00

(52) U.S. Cl. CPC G07C 5/008; G06Q 10/20; G07C 5/006; G07C 5/0841

(57) ABSTRACT

Systems, media, and methods for analyzing vehicle health information to generate opportunity for dealerships by performing ingress and aggregation of vehicle data for a plurality of vehicles, the vehicle data originated, at least in part, from vehicle telematics systems; predicting future vehicle events by application of one or more machine learning models to the vehicle data; and providing a dealership vehicle health and information portal comprising: a dashboard presenting current vehicle system state for each vehicle in the plurality of vehicles and vehicle event history for each vehicle in the plurality of vehicles, an opportunity genie presenting predicted future vehicle events for each vehicle in the plurality of vehicles and cost estimates for performing currently needed and predicted repairs, and a notification rule engine allowing a dealership user to define rules for customized, automated consumer notifications, wherein each rule comprises a triggering vehicle event and a message.

### CROSS-REFERENCE TO RELATED APPLICATIONS

This application claims the benefit of U.S. Application Ser. No. 62/357,286, filed Jun. 30, 2016, the entire contents of which are hereby incorporated by reference.

### BACKGROUND OF THE INVENTION

With the advance of sensors and computer technologies, information concerning the state of health of various parts of a motor vehicle is available in real time and can be stored on-board, extracted, exported and analyzed off-board. From a health, status, and service perspective, fully utilizing this vehicle health information may prolong the vehicle life and improve vehicle safety. However, the storage of this information is fragmented and its utilization is cumbersome because this information resides in multiple on-board systems and is not wholly actionable for a dealer service provider or an end consumer. For example, many owners of vehicles only bring their vehicles to the dealer for service when the engine light is on although their vehicle computer systems has accumulated data indicative of potential engine troubles days or weeks earlier.

On one hand, the failure of the vehicle owner to be aware of this type of potential vehicle problems is unfortunate since the vehicle owner cannot read or understand the health data about his vehicle, which is available from the vehicle's computers. On the other hand, vehicle maintenance providers, such as dealer service provider (DSP), are capable of reading and analyzing health data about many vehicles but have no access to the vehicles. This results in an incomplete experience as a consumer from an ownership perspective and potential lost opportunities from a DSP perspective. To further exacerbate the problem, many old vehicles do not come with telematics hardware on board to allow vehicle health data export. There is a need to bridge the gap between a vehicle owner who has access to vehicle data but has no expertise to use the data and a DSP who has expertise to use the data but has no access to the data.

### SUMMARY OF THE INVENTION

To the best knowledge of the applicants, no other current technology provides a complete solution to the afore-mentioned problem which includes all of the following aspects:
Dealerships with the ability to see vehicle health information from their customers on a daily basis such as when standard maintenance is due based on, for example, actual miles driven or what type of repair service is required based on the vehicles fault code;
Scheduling optimization based on the Diagnostic Trouble Codes (DTC) with estimated time for repair and potential associated revenue;
Turning older model vehicles into connected vehicles through the use of an On-Board Diagnostics II (ODBII) dongle, that provides a means to extract vehicle health information regularly (hourly, daily, monthly, or as needed or requested by the dealership) and communicating via Code Division Multiple Access (CDMA)/Global system for Mobile Communications (GSM)/802.11.x or other mobile communications network either directly through the device via a modem or through a tethered Bluetooth connection to any mobile phone or modem;
Giving car dealerships the ability to reach out to customers directly when service is needed for a vehicle in an automated way via email, text, or through instant messaging within a mobile device application;
Through the use of a mobile device, vehicle owners have the ability to immediately schedule their vehicle for service based on the appropriate amount of time required for the repair, the dealerships availability, the urgency of the repair, length of time required, and part available; and
Vehicle owners immediately see the severity of the trouble code, the most appropriate action, and estimated cost via a mobile application.

In contract, the present disclosure provides a system which allows older and newer vehicles connected with a single system and a single source of vehicle health diagnostic tool for past, current, and predicted vehicle health and service needs.

The present disclosure bridges an existing gap by providing a system to analyze DTC codes, determine relevant SPG codes, as well as DTC codes, work hours, estimates, required resource skillsets, identify necessary parts, and provide time estimations. Moreover, this present disclosure provides a facility for the DSP to directly connect with consumers and schedule visits, maximize shop throughput, provide accurate time estimations to end consumers, provide a concierge level quality service to their consumers, and reduce the overall time that their consumer has to wait when dropping a vehicle off for service.

In one aspect, disclosed herein is a computer-implemented system comprising: a digital processing device comprising: at least one processor, an operating system configured to perform executable instructions, a memory, and a computer program including instructions executable by the digital processing device to create a vehicle health and information application comprising: a software module performing ingress and aggregation of vehicle data for a plurality of vehicles and storing the vehicle data in a central storage, the vehicle data originated, at least in part, from vehicle telematics systems; a software module predicting future vehicle events by application of one or more machine learning models to the vehicle data; and a software module providing a dealership vehicle health and information portal comprising: a dashboard presenting current vehicle system state for each vehicle in the plurality of vehicles and vehicle event history for each vehicle in the plurality of vehicles, an opportunity genie presenting predicted future vehicle events for each vehicle in the plurality of vehicles and cost estimates for performing currently needed and predicted repairs, and a notification rule engine allowing a dealership user to define rules for customized, automated consumer notifications, wherein each rule comprises a triggering vehicle event and a message.

In another aspect, disclosed herein is a non-transitory computer-readable storage media encoded with a computer program including instructions executable by a processor to create a vehicle health and information application comprising: a software module performing ingress and aggregation of vehicle data for a plurality of vehicles and storing the vehicle data in a central storage, the vehicle data originated, at least in part, from vehicle telematics systems; a software module predicting future vehicle events by application of one or more machine learning models to the vehicle data; and a software module providing a dealership vehicle health and information portal comprising: a dashboard presenting current vehicle system state for each vehicle in the plurality of vehicles and vehicle event history for each vehicle in the plurality of vehicles, an opportunity genie presenting predicted future vehicle events for each vehicle in the plurality of vehicles and cost estimates for performing currently needed and predicted repairs, and a notification rule engine allowing a dealership user to define rules for customized, automated consumer notifications, wherein each rule comprises a triggering vehicle event and a message.

In another aspect, disclosed herein is a computer-implemented method of managing vehicle health information to generate opportunity for dealerships comprising: performing, at a computer, ingress and aggregation of vehicle data for a plurality of vehicles and storing the vehicle data in a central storage, the vehicle data originated, at least in part, from vehicle telematics systems; predicting, at the computer, future vehicle events by application of one or more machine learning models to the vehicle data; and providing, by the computer, a dealership vehicle health and information portal comprising: a dashboard presenting current vehicle system state for each vehicle in the plurality of vehicles and vehicle event history for each vehicle in the plurality of vehicles, an opportunity genie presenting predicted future vehicle events for each vehicle in the plurality of vehicles and cost estimates for performing currently needed and predicted repairs, and a notification rule engine allowing a dealership user to define rules for customized, automated consumer notifications, wherein each rule comprises a triggering vehicle event and a message.

### BRIEF DESCRIPTION OF THE DRAWINGS

FIG. 1 shows a non-limiting example of a communication network employing and enabled by the present disclosure; in this case, a technology overview of the communication network describing the overall technical solution of the present disclosure involving hardware and software components in a broad stroke.

FIG. 2 shows a non-limiting example of a general flow chart depicting the movement of data; in this case, a data flow chart which illustrates how data moves from various external systems into the platform/system/method of the present disclosure, is utilized, and then presented.

FIG. 3 shows a non-limiting example of technologies used in certain aspects of the present disclosure; in this case, a tabulation of specific technologies involved at specific step of the present disclosure.

FIG. 4 shows a non-limiting example of an operation of the method disclosed in the present application; in this case, a dealer login page when using Dealer Dashboard disclosed in the present disclosure.

FIG. 5 shows a non-limiting example of an operation of the method disclosed in the present application; in this case, a Dealer Dashboard featuring Opportunity Genie.

FIG. 6 shows a non-limiting example of an operation of the method disclosed in the present application; in this case, a Vehicle Details Page (VDP).

FIG. 7 shows a non-limiting example of a digital processing device; in this case, a device with one or more CPUs, a memory, a communication interface, and a display.

FIG. 8 shows a non-limiting example of a web/mobile application provision system; in this case, a system providing browser-based and/or native mobile user interfaces.

FIG. 9 shows a non-limiting example of a cloud-based web/mobile application provision system; in this case, a system comprising an elastically load balanced, auto-scaling web server and application server resources as well synchronously replicated databases.

### DETAILED DESCRIPTION OF THE INVENTION

There are about 162 million vehicles on the road today which are equipped with complex maintenance systems but are without embedded telematics or diagnostic connectivity. At one end of the spectrum, consumers driving these vehicles do not know the health state of their vehicles until they notice a check engine light go on their vehicles. At the other end of the spectrum, dealers are kept in the dark about their customers' vehicles and have little awareness or information about the issues a customer's vehicle may have unless the vehicle comes in for service.

When a vehicle comes in for service at a DSP, the DSP struggles with maximizing shop time and efficiency because the health state, SPG codes as well as DTC codes of the vehicle, and work hours, estimates, required resource skillsets required for the maintenance work are largely unknown or in disjointed systems before the current service. Current Customer Relationship Management (CRM) solutions at the dealership are incapable of estimating shop time and also end consumer cost prior to a visit because they do not have specific DTCs from consumer vehicles until the vehicle is in the shop.

Described herein, in certain embodiments, are vehicle health and information platforms that utilize various vehicle eventing systems and integrations with third party platforms to aggregate a single source of truth for past, present, and predictive information about vehicles and then provide this information to consumers and dealer service providers.

Also described herein, in certain embodiments, are vehicle eventing subsystems that include systems from embedded manufacturer based telematics systems and post vehicle production first and third party telematics devices. Examples of the data received from these eventing subsystems include, but are not limited to, DTC codes, as well as time based vehicle information such as location coordinates via global positioning system (GPS) and/or cell phone triangulation, vehicle battery voltage, vehicle fuel level, vehicle speed and acceleration, vehicle altitude, and vehicle odometer readings.

Also described herein, in certain embodiments, are integrations with third party platforms that include, but are not limited to, wireless assistance services (WAS), paid for and free services that provide two-way integration with a customer's vehicle to aid the customer at a point of need, and customer relationship management (CRM) platforms. Such integrations build systems that can provide dealers, manufacturers, and service providers with the ability to track the history of a consumer and their vehicle(s). Examples of the data received via these integrations include, but are not limited to, services performed on a vehicle, consumer inquiries, consumer visits, and consumer personal data (name, address, etc).

Also described herein, in certain embodiments, are platform integration systems that can be configured via push, pull, or socket based interfaces, and can accept data from a variety of telematics hardware, or third party platforms.

Also described herein, in certain embodiments, are methods to store and analyze data received by the systems. For example, all data received by eventing subsystems or integrations for all vehicles are stored in a central data system. On the ingress of data for a particular vehicle, the incoming data is mated to historical vehicle service data, and proprietary analytics and machine learning models are applied to determine a variety of extrapolated and interpolated data points. Based on rules and notification templates configured by an authorized subscriber for his/her vehicles, SMS/email/mobile push notifications are automatically generated and sent for an authorized subscriber or anyone deemed relevant to the information. This calculated and merged data is paired with consumer personal data and presented to the authorized subscriber via a dashboard.

Also described herein, in certain embodiments, are the vehicle health and information events dashboard which provides intelligent awareness of the vehicle's health and status to the aim of providing insight, via traditional extrapolation, as well as interpolation via modern data science including trend based analytics, predictive analytics and machine intelligence. Traditional extrapolation includes immediate state indicators, such as “due for an oil change today,” or “Powertrain failure code P0014 reported by ECU, suggest service immediately.” The dashboard in the present disclosure provides an authorized subscriber with awareness to these DTC error codes, as well as cost estimates for service based on proprietary data.

Also described herein, in certain embodiments, are trend-based, predictive analytics, machine learning and other modern data science techniques that provide insight and alert into the state of a vehicle based on a combination of aggregate non-personal information from other similar drivers or vehicles, and historical usage and service data for that vehicle itself. Example of such alert include, but are not limited to, “95% of drivers of the same model/make/year of a given vehicle performed their first oil change at 5,500 instead of 5,000 miles as indicated by the manufacturer,” or “based on your driving speed, braking, and acceleration, you will need to change your tires every 8,000 miles.”

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, the term “telematics” refers to the fields of telecommunications and informatics applied in wireless vehicle information technologies.

As used herein, the term “GSM” refers to global system for mobile communications, which is a standard developed by the European Telecommunications Standards Institute (ETSI) to describe the protocols for second-generation (2G) digital cellular networks used by mobile phones. It functions on four distinct frequency bands, 900 MHz and 1800 MHz in Europe and Asia, and 850 MHz and 1900 MHZ in North and South America.

As used herein, the term “TMDA” refers to time division multiple access, which divides the frequency bands into multiple channels. GSM uses a variant of TMDA to transform voice into digital data, which is given a channel and a time slot. The receiver of the GSM signal listens only to the assigned time slot, with the call pieced together.

As used herein, the term “CDMA” refers to code division multiple access, which is a channel access method used by various radio communication technologies. CDMA is an example of multiple access, where several transmitters can send information simultaneously over a single communication channel. This allows several users to share a band of frequencies.

As used herein, the term “DTC” refers to diagnostic trouble code, usually a series of five letters and numbers (such as P0300) that tells automotive service technicians what's wrong with parts of the vehicle tested, for example, engine, emissions controls and other components, according to the vehicle's on-board diagnostics system. Current computerized engine control system can self-diagnose and detect vehicle problems that could affect a vehicle's emissions and engine performance. When the engine control system detects a problem, the computer stores the diagnostic trouble code in its memory. For most vehicles, to obtain the diagnostic trouble code, a technician has to plug in a diagnostic trouble code reader (DTC Reader) or scan tool into the computer system of the vehicle.

As used herein, the term “OBD-II” refers to second-generation on-board diagnostics systems, which use a standardized digital communications port to provide real-time data in addition to a standardized series of DTCs, which allow a technician to rapidly identify and remedy malfunctions within the vehicle. The OBD-II standard specifies the type of diagnostic connector and its pinout, the electrical signaling protocols available, and the messaging format. It also provides a candidate list of vehicle parameters to monitor along with how to encode the data for each. There is a pin in the connector that provides power for the scan tool from the vehicle battery, which eliminates the need to connect a scan tool to a power source separately. OBD-II DTCs are 4-digit, preceded by a letter: P for engine and transmission (powertrain), B for body, C for chassis, and U for network.

As used herein, the term “CAN bus” refers to any bus or bus system used in a vehicle for communicating signals, data, and/or messages between electronic control units (ECUs) or components. CAN bus can mean any bus linking active components of a vehicle and any bus conveying data representative of the performance of those components. The CAN bus may be a bus that operates according to versions of the CAN specification, but is not limited thereto. CAN bus can therefore refer to buses that operate according to other specifications, including those that might be developed in the future.

As used herein, the term “ontology” refers to a formal naming and definition of the types, properties, and interrelationships of the entities that really or fundamentally exist for a particular domain of discourse, as commonly used in computer science and information science. Ontology is thus a practical application of philosophical ontology, with a taxonomy. For example, an ontology can compartmentalize the variables needed for some set of computations and establishes the relationships between them.

### Vehicle Data

In some embodiments, the platforms, systems, media, and methods described herein include a vehicle data, or use of the same.

Modern vehicles are complex electro-mechanical systems with many networked ECUs, which enable or implement vehicle core functions such as power-train control, suspension control, safety, convenience functions, and infotainment. ECUs are connected to a large number of sensors and actuators which ECUS control. In addition, ECUs exchange information about their current sensor values over internal networks, including CAN bus, so that multiple redundant sensors are avoided. Data stored on and exchanged between ECUs describe the health state of the vehicle in real time. However, the data volume generated from tens or hundreds of sensors in real time can be so large that analysis of the data in real time may be a problem. Therefore, it is necessary to utilize filter and data aggregation/integration mechanism to select specific data in selected situations for analysis, enabled by the platforms, systems, media, and methods described herein.

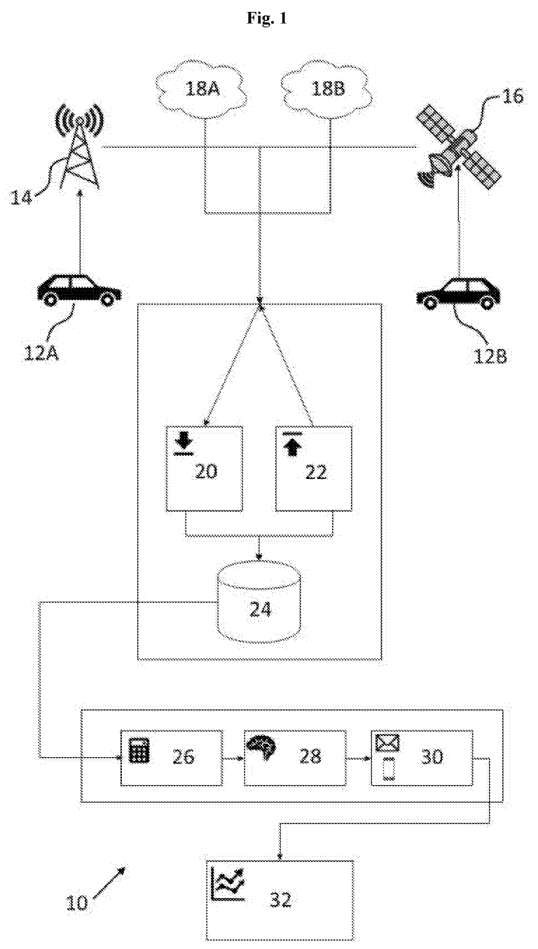

Referring to FIG. 1, a communication network 10 and vehicles 12A and 12B according to one embodiment of the present disclosure are illustrated. According to FIG. 1, vehicle 12A may communicate with a cellular service provider 14, providing vehicle information (including vehicle health information) and/or receiving service provider's communication. Alternatively, vehicle 12B may communicate with a communication satellite 16, providing vehicle information and/or receiving service provider's communication. Further, both the cellular service provider 14 and the communication satellite 16 may communicate with each other and further with land network 18A and /or other distributed data network 18B such as the Internet. The vehicle information may further be transmitted to web server 20 and/or application server 22, both of which may be in communication with a database 24.

The database 24 can store account information such as subscriber information and historical information, including but not limited to vehicle health history information of the vehicle, maintenance history information of the vehicle, factory recall history of the vehicle, common problems/trends of vehicle health associated with the vehicle class, or other historical data associated with the subscriber/vehicle. Data transmissions may also be conducted by wireless systems, such as 802.11.x, GPRS, and the like. All of the historical information can be updated with the recently received vehicle information or data from other sources.

Based on the historical data and the recently received data from the vehicle, systems, media, and methods described herein can be employed to analyze the recently received data and suggest maintenance solutions. Maintenance solutions thus generated can be communicated to personal electronic device 26 of the user, user or user representative 28, and electronic message device or personal cell phone 30 of the user. The personal electronic device may be a fax machine or a desk phone. In addition, the maintenance solutions thus communicated may include trend analysis 32 including future predictions for maintenance need.

It should be noted FIG. 1 is exemplary. Therefore, it is not in any way limiting the scope of the present disclosure. For example, although vehicles 12A and 12B seem to be personal vehicles, other vehicles, such as truck or bus, are included in the present disclosure.

### Data Flow

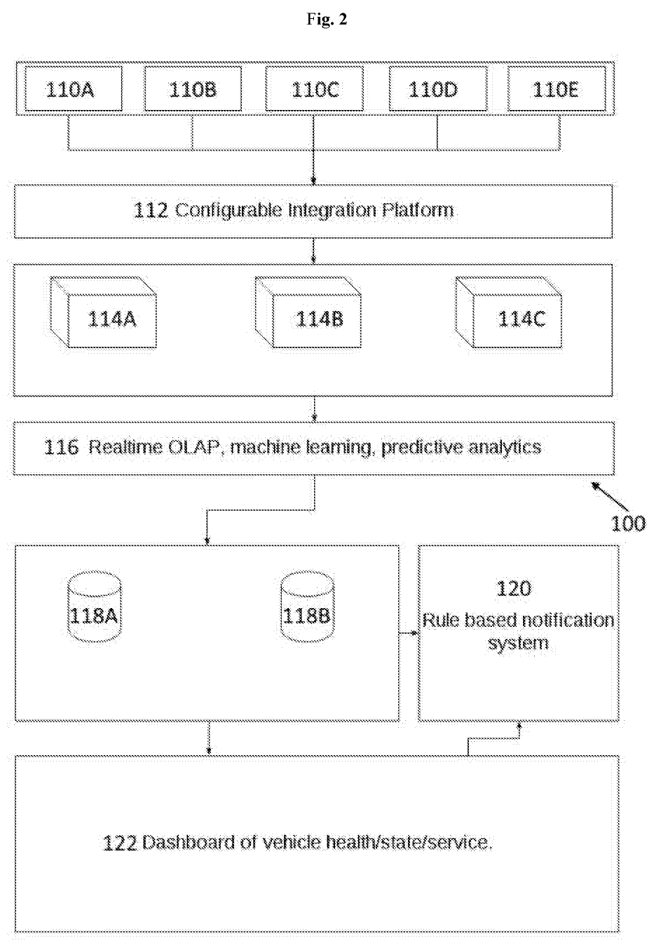

Referring to FIG. 2, a diagram of one embodiment of the present disclosure illustrates the data flow employed by the platform/system/method disclosed herein. At the start, data from Onboard Telematics 110A, Add-on Telematics 110B, WAS systems 110C, Mobile-based Telematics 110D and CRM systems 110E can be transmitted Configurable Integration Platform 112 where the received data from 110A-110E can be manipulated according to rules/methods disclosed herein, then saved in highly available ingress data stores including 114A, 114B and 114C. The ingress data stored can be further processed by analytic tools 116 including Realtime OLAP, machine learning, and predictive analytics. OLAP stands for online analytical processing which performs multidimensional analysis of business data and provides the capability for complex calculations, trend analysis, and sophisticated data modeling. The processed data are then stored in highly available post calculation data store 118A and 118B. At this junction, the post calculation data can be subjected to the rule-based notification system 120 to suggest maintenance recommendations sent to the customer/dealer. Further, the post calculation data can be provided to the dashboard of vehicle health/state/service 122 for the further analysis and/or dealer intervention, after which the data can be transmitted to the rule-based notification system 120 as refined data.

### Technologies Involved

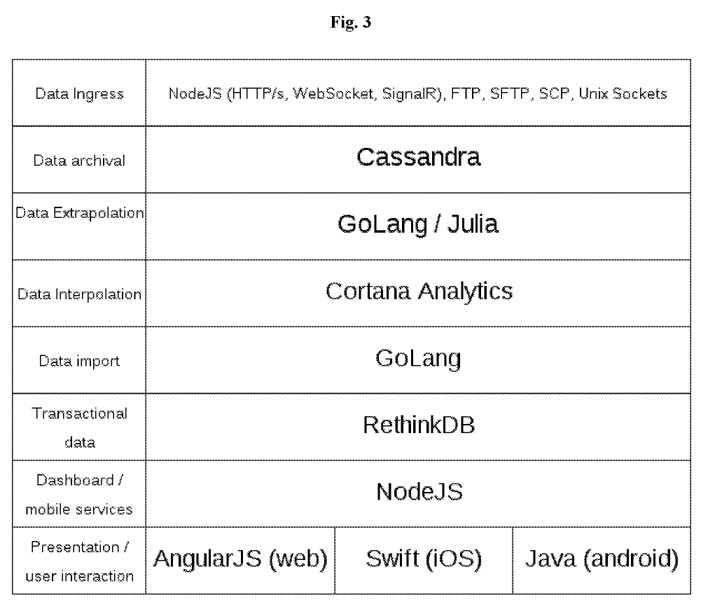

As showed in FIGS. 1-2, vehicle data can be transmitted and/or process at various steps of the methods of the present disclosure. FIG. 3 displays various technologies that can be employed to facilitate data flow when using the platform/system/method of the present disclosure. It should be noted that the technologies shown in FIG. 3 are exemplary, not exclusive or limiting in any way.

### Dealer Dashboard

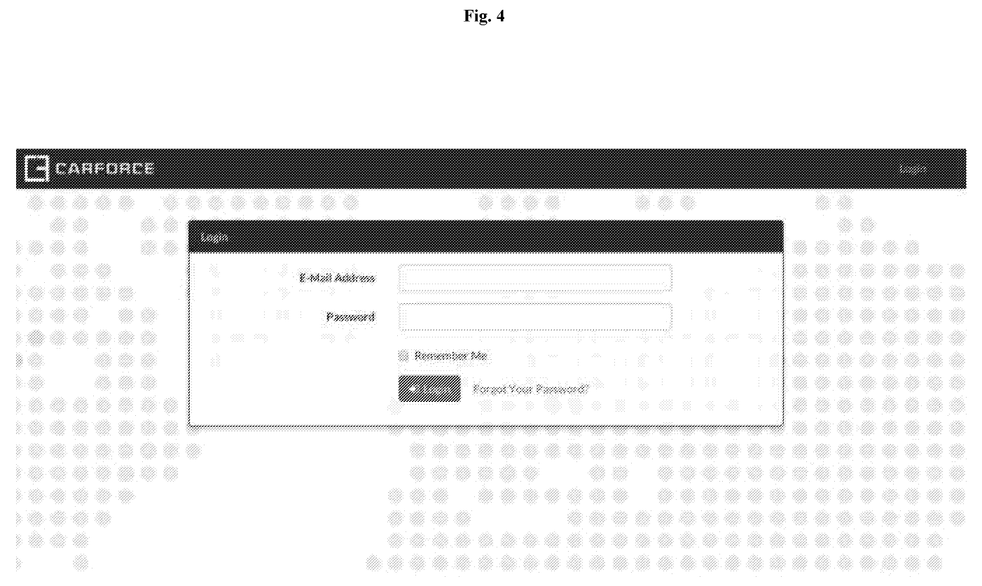

FIGS. 4-7 depict the user interface (UI) of a DSP application for one embodiment of the platform/system/method of the present disclosure. Upon accessing the webpage for the Deal Dashboard, a user is required to provide her login name (shown as the user's email address) and a password, as shown in FIG. 4. Other forms of login are also allowed.

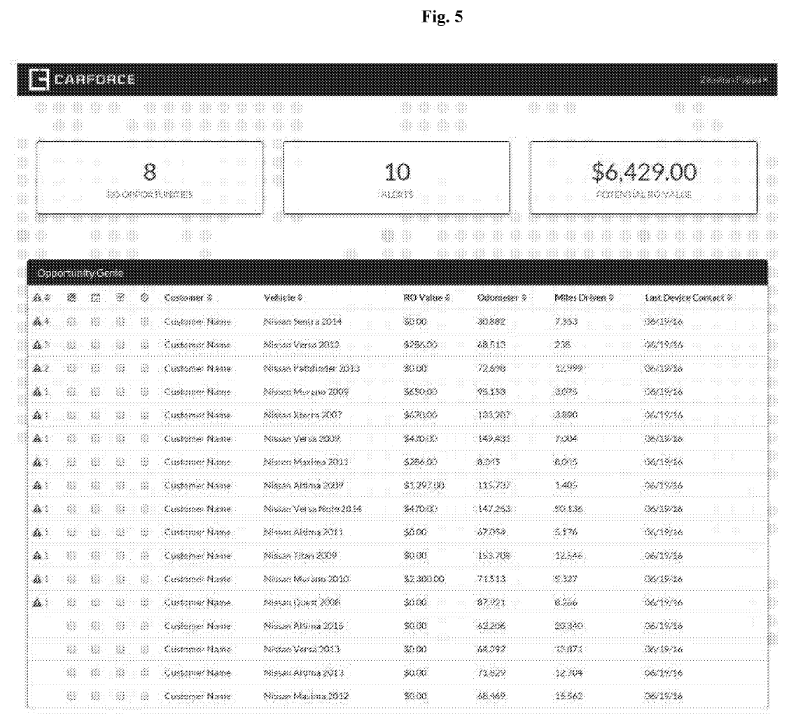

Once in the Dealer Dashboard environment, there are many different applications to choose from, including but not limited to, Opportunity Genie, Sales Genie, and Scheduling Genie. Taking the Opportunity Genie for example, as shown in FIG. 5, the user of the application can get access to a plurality of potential maintenance opportunities for multiple customers. The portal of the Opportunity Genie, as shown in FIG. 5, presents each maintenance opportunity with selected detailed information, including, but not limited to, Customer Name, Customer's vehicle type and year, certain data about the vehicle, and the last contact date.

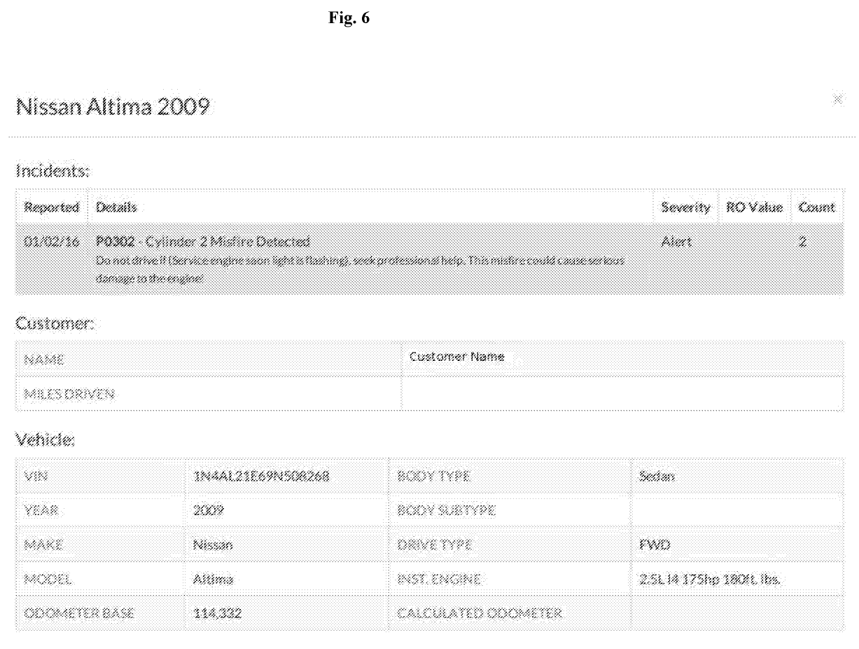

If the user of the application is interested to explore one particular maintenance opportunity, she can just click on the maintenance opportunity and a new Vehicle Details Page (VDP) as shown in FIG. 6 will show up. VDP can present information such as maintenance incidents, customer information and vehicle information in more details. The user can review all the data and made an educated and informed decision on what maintenance option should be recommended to this specific vehicle.

### Predicting Future Vehicle Events

In some embodiments, the platforms, systems, media, and methods described herein include predicting future vehicle events. In further embodiments, future vehicle events are predicted by the application of machine learning models or other predictive analytic methodologies.

### Vehicle Health and Information Portal

In some embodiments, the platforms, systems, media, and methods described herein include a vehicle health and information portal future vehicle events.

In some embodiments, the present disclosure includes a dashboard presenting current vehicle system state for each vehicle in the plurality of vehicles and vehicle event history for each vehicle in the plurality of vehicles.

In some embodiments, the present disclosure includes an opportunity genie presenting predicted future vehicle events for each vehicle in the plurality of vehicles and cost estimates for performing currently needed and predicted repairs.

In some embodiments, the present disclosure includes a notification rule engine allowing a dealership user to define rules for customized, automated consumer notifications, wherein each rule comprises a triggering vehicle event and a message.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia Symbian® OS, Apple® iOS®, Research In Motion® BlackBerry OS®, Google®Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV ®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with the digital processing device, such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

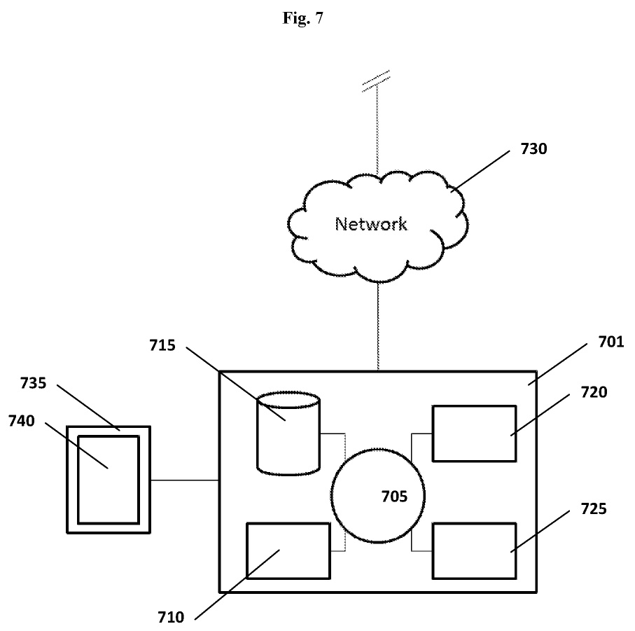

Referring to FIG. 7, in a particular embodiment, an exemplary digital processing device 701 is programmed or otherwise configured to ingest vehicle data, including telematics data, predict future vehicle events, and provide a dealership vehicle health and information portal. The device 701 can regulate various aspects of data analytics of the present disclosure, such as, for example application of machine learning. In this embodiment, the digital processing device 701 includes a central processing unit (CPU, also “processor” and “computer processor” herein) 705, which can be a single core or multi core processor, or a plurality of processors for parallel processing. The digital processing device 701 also includes memory or memory location 710 (e.g., random-access memory, read-only memory, flash memory), electronic storage unit 715 (e.g., hard disk), communication interface 720 (e.g., network adapter) for communicating with one or more other systems, and peripheral devices 725, such as cache, other memory, data storage and/or electronic display adapters. The memory 710, storage unit 715, interface 720 and peripheral devices 725 are in communication with the CPU 705 through a communication bus (solid lines), such as a motherboard. The storage unit 715 can be a data storage unit (or data repository) for storing data. The digital processing device 701 can be operatively coupled to a computer network (“network”) 730 with the aid of the communication interface 720. The network 730 can be the Internet, an internet and/or extranet, or an intranet and/or extranet that is in communication with the Internet. The network 730 in some cases is a telecommunication and/or data network. The network 730 can include one or more computer servers, which can enable distributed computing, such as cloud computing. The network 730, in some cases with the aid of the device 701, can implement a peer-to-peer network, which may enable devices coupled to the device 701 to behave as a client or a server.

Continuing to refer to FIG. 7, the CPU 705 can execute a sequence of machine-readable instructions, which can be embodied in a program or software. The instructions may be stored in a memory location, such as the memory 710. The instructions can be directed to the CPU 705, which can subsequently program or otherwise configure the CPU 705 to implement methods of the present disclosure. Examples of operations performed by the CPU 705 can include fetch, decode, execute, and write back. The CPU 705 can be part of a circuit, such as an integrated circuit. One or more other components of the device 701 can be included in the circuit. In some cases, the circuit is an application specific integrated circuit (ASIC) or a field programmable gate array (FPGA).

Continuing to refer to FIG. 7, the storage unit 715 can store files, such as drivers, libraries and saved programs. The storage unit 715 can store user data, e.g., user preferences and user programs. The digital processing device 701 in some cases can include one or more additional data storage units that are external, such as located on a remote server that is in communication through an intranet or the Internet.

Continuing to refer to FIG. 7, the digital processing device 701 can communicate with one or more remote computer systems through the network 730. For instance, the device 701 can communicate with a remote computer system of a user. Examples of remote computer systems include personal computers (e.g., portable PC), slate or tablet PCs (e.g., Apple® iPad, Samsung® Galaxy Tab), telephones, Smart phones (e.g., Apple® iPhone, Android-enabled device, Blackberry®), or personal digital assistants.

Methods as described herein can be implemented by way of machine (e.g., computer processor) executable code stored on an electronic storage location of the digital processing device 101, such as, for example, on the memory 710 or electronic storage unit 715. The machine executable or machine readable code can be provided in the form of software. During use, the code can be executed by the processor 705. In some cases, the code can be retrieved from the storage unit 715 and stored on the memory 710 for ready access by the processor 705. In some situations, the electronic storage unit 715 can be precluded, and machine-executable instructions are stored on memory 710.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

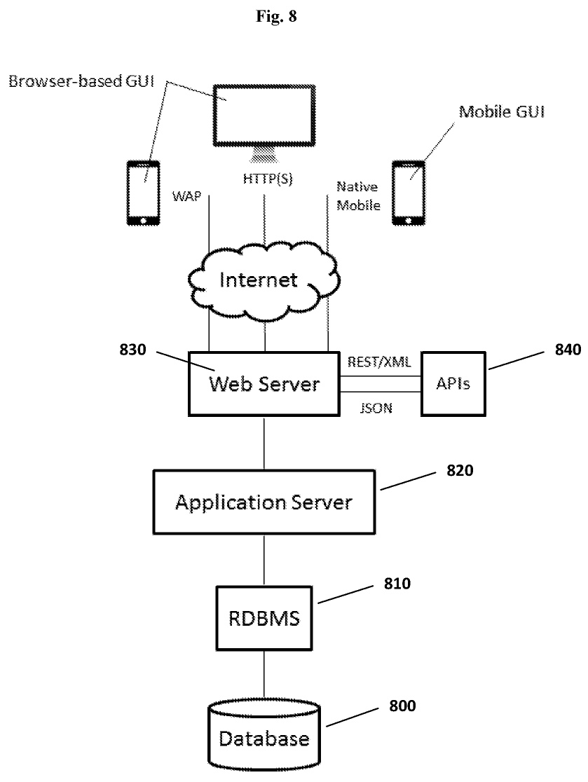

Referring to FIG. 8, in a particular embodiment, an application provision system comprises one or more databases 800 accessed by a relational database management system (RDBMS) 810. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 820 (such as Java servers, .NET servers, PHP servers, and the like) and one or more web servers 830 (such as Apache, IIS, GWS and the like). The web server(s) optionally expose one or more web services via app application programming interfaces (APIs) 840. Via a network, such as the Internet, the system provides browser-based and/or mobile native user interfaces.

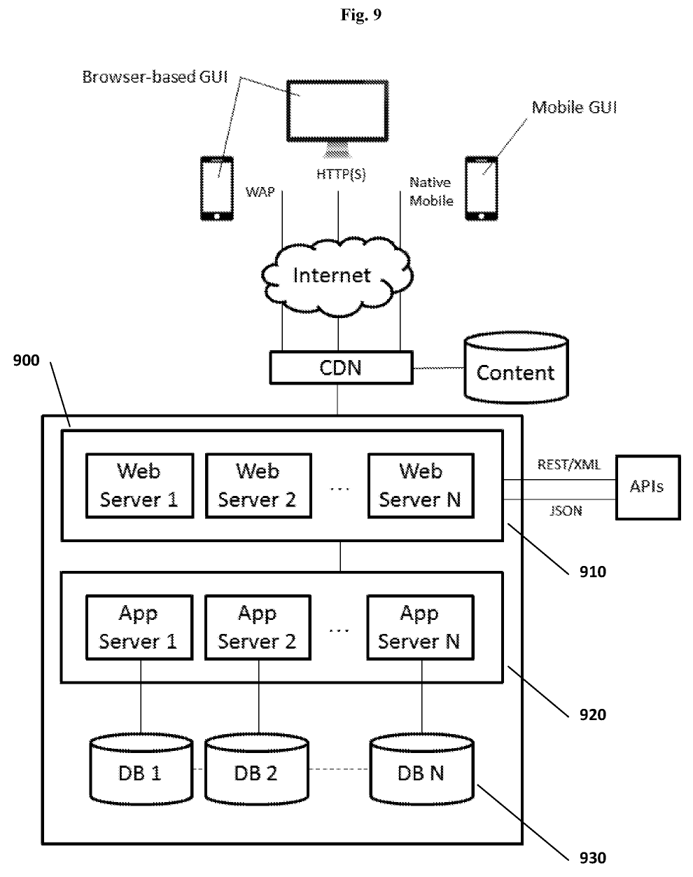

Referring to FIG. 9, in a particular embodiment, an application provision system alternatively has a distributed, cloud-based architecture 900 and comprises elastically load balanced, auto-scaling web server resources 910 and application server resources 920 as well synchronously replicated databases 930.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of vehicle, dealership, and owner information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1—Configurable Integration Framework for Data Ingress from Telematics Devices & Third Party CRM/WAS systems

The present disclosure contains a facility that enables a technical operator to configurably define and implement an integration platform/process of data extracted from an embedded or aftermarket vehicle telematics platform or device or third party CRM/WAS system. This integration platform/process drives associated services that can accept data from external systems on demand as well as retrieve data from external systems via a recurrence pattern.

In one embodiment, a technical operator can define at least one “.icfg” (Integration Configuration) document as a document to define an integration within the integration framework. Each .icfg document includes, but is not limited to, the following pieces of information:

1) Name—String

2) Description—String

3) Integration Type—Select from enumerated List (Real Time Push, Scheduled)

4) Recurrence Pattern—Available if Integration Type is Scheduled. Allows for a string that follows the Linux crontab convention for defining recurrence patterns.

5) Transport Protocol—Select from enumerated List (FTP, SFTP, SCP, HTTP, HTTPS, WebSockets, SignalR, UDP). Web Sockets, SignalR, UDP are not available for Integration Type Scheduled.

6) Real Time Push Route—Available if Integration Type is Real Time Push—route of the Real Time Push Client, i.e., push.carforce.io/PushClient1.

7) URL—Available if Integration Type is Scheduled—String that defines at what URL the integration service should connect to.

8) Port—Available if Transport Protocol is WebSockets, SignalR, or UDP.

9) Credentials Available if Integration Type is Scheduled or Transport Protocol is FTP/SFTP/SCP.
(a) Credential Type—enumerated list (Password, private key)
(b) Username (If credential type is password)
(c) Password (If credential type is password)
(d) Private Key (if credential type is private key)

10) API Key (If Integration Type is Real Time Push)
(a) API Key—String of secret key that real time push clients will use to enter data for this integration

11) Data Compression Format
(a) Select from enumerated List (None, Zip, 7zip, Rar, tar.gz, tar.bz)

12) Data Granularity—Batch or Single (Only Batch is available if Integration Type is Scheduled).

13) Document Cardinality—In the case of a Data Granularity of Batch this field provides two values 1 and N. 1 Specifies that a single document contains the batch records. N specifies that multiple documents contain batch records, 1 per document.

14) Data Directory—Available if Integration Type is Scheduled or if Transport Protocol is FTP/SFTP/SCP. Is a string that defines the unique location of remote data or where a remote host places data on the integration servers.

15) Data Encoding Format
(a) Select from enumerated List (XML, JSON, Fixed Field, Comma Delimited,

Pipe Delimited, Binary)

16) Root List Element—(If XML or JSON selected and Data Granularity is Batch and Document Cardinality is 1). Identifies the root list element of the exported document via a dotted notation path or XPath Query. This is the element path in the document which contains the batch series data.

17) Document Length—(If Fixed field length is selected and Data Granularity is Batch and Document Cardinality is 1). This identifies the document length in characters for a given document.

18) Document Delimiter Length—(If Fixed field length is selected and Data Granularity is Batch and Document Cardinality is 1). This is an optional field which specifies the length of delimiters between documents in fixed field batch formats

19) Binary Interpreter—Available if Data Encoding Format is Binary, string to command of binary interpreter that will decode the provided binary file into a JSON document before attempting to translate and import it.

20) Translation Matrix—Select from user populated List of defined translation matrices (.itrm documents) the available list is based on the selected data encoding format, or in the case of a binary format, the translation matrix is limited to JSON compatible translation matrices.

A technical operator can define at least one .itrm (Translation Matrix) document, which is a document to encapsulate the mapping of external document data formats to its own internal ontology. Each .itrm document includes, but is not limited to, the following pieces of information:

1) Data Encoding Format
(a) Select from enumerated List (XML, JSON, Fixed Field, Comma Delimited, Pipe Delimited)

2) CustomerInformation*

3) CustomerIncidents*

4) CustomerMessages*

5) VehicleInformation*

6) VehicleIncident*

7) Vehicle Service History*

*Items 2)-7) are list fields that correspond to collections in this disclosure's ontology that accepts many data entries of the following format:
(i) Canonical Field Name (i.e., customer.firstName or customer.messages)
(ii) Associated Field
   A) For XML Documents, XPATH Query to the Field or Object, i.e., /customer[@first_name]
   B) For JSON Documents, dotted notation path to the field or Object, i.e., “customer.first_name.”
   C) For Fixed Field, enter starting index and ending index of field.
   D) For Comma Delimited and Pipe Delimited, enter Column Name or Column Number (starting from 0).

A technical operator can create these documents using a simple administrative access configuration user interface (UI) for each integration with vehicle telematics platforms or devices (embedded and/or aftermarket) and third party CRM and WAS systems which then stores these documents into the Integration Metadata Repository (IMR), a persistent memory store based on Redis.

Redis is an open source, in-memory data structure store, used as database, cache and message broker. It supports data structures such as strings, hashes, lists, sets, sorted sets with range queries, bitmaps, hyperloglogs and geospatial indexes with radius queries. Redis has built-in replication, Lua scripting, LRU eviction, transactions and different levels of on-disk persistence, and provides high availability via Redis Sentinel and automatic partitioning with Redis Cluster.

An Integration Metadata Repository (IMR) is a database created to store metadata. Metadata is information about the structures that contain the actual data. Metadata is data about the structures that contain data. Metadata may describe the structure of any data, of any subject, stored in any format.

The IMR is made available to the Integration Framework Cluster (IFC), which is a collection of highly available nodes that provide services based on the IMR. There are 5 types of IFC Nodes. All IFC nodes run on Linux containers.

1) Type Z—Singular master node which handles distribution of workload for scheduled data retrieval and data translation services. Workload is distributed via round robin distribution. This node also manages notification of newly ingressed data availability to subscriber services such as AFC Type J Nodes by populating data through a shared message queue.

2) Type A—Provides Real Time push integration services for HTTP/HTTPS/WebSocket/SignalR/UDP based on .icfg documents. These nodes utilize NodeJS to provide HTTP/HTTPS/WebSocket/SignalR/UDP services for Real Time Push Integrations. Upon startup or publish of IMR data to a Type A IFC Node, configuration data is read from the IMR and routes and socket listeners are automatically provisioned. Type A IFC Nodes are load balanced via external software (Nginx) or L4 hardware load balancer and provide sticky sessions. Type A Nodes store their incoming data into a shared object cache and notify the Type Z node when they have successfully saved incoming data.

3) Type B—Provides scheduled integration services for HTTP/HTTPS/FTP/SFTP/SCP based on .icfg documents. Type B IFC Nodes utilize NodeJS and open source libraries for FTP/SFTP/SCP connectivity to external systems. Type B IFC Nodes receive jobs from the Type Z IFC Node via a shared message queue. A job in this context is simply a command to access the defined remote location and retrieve data. Type B Nodes store this incoming data into a shared object cache and notify the Type Z node when they have successfully saved incoming data.

4) Type C—Provides Real Time push integration services for FTP/SFTP/SCP based on .icfg documents. Type C nodes utilize interfaces for underlying open source services for FTP/SFTP/SCP(SSH) connectivity such as ftp, and openssh. Underlying configuration is automatically provisioned with usernames & passwords or private keys based on the .icfg document, utilizing interfaces to common system commands on linux such as adduser and passwd. User accounts that are created are automatically jailed using interfaces to common commands on Linux such as chown and chmod so that downstreams users do not have access to other user's data. Folders are automatically created based on the .icfg document inside the user accounts jailed directory. File system watchers watch these directories for incoming files and move new files to the shared object cache and notify the Type Z node when the operation is complete. Type C nodes are load balanced via an external software or hardware load balancer and provide sticky sessions.

5) Type X—Provides Data Translation Services based on .itrm documents. Type X nodes are responsible for translating and ingressing data into the canonical format. Type X IFC Nodes receive jobs from Type Z Nodes via a shared message queue. A job in this context is simply a command to access the source document located in the object cache, and programmatically translate it based on the .itrm document. The programmatic translation works based on the definition in an .itrm document.
Data Documents which are configured with a compression format are automatically decompressed using common and available system level decompression tools.

Before a document is translated its granularity needs to be addressed. Because this integration framework handles both Single and Batch level granularity, Batch level granularity documents are converted to Single documents for internal processing via the following logic:
Data Documents for integrations with a Document Cardinality of 1 which are batch documents of records contained in a single document are split in memory into singular records.
In the case of XML/JSON documents, then the Root List Element is used to identify the document node which contains the batch series data.
In the case of Fixed Field Format the Document Length and Document Delimiter Length fields are utilized to determine the offset markers for individual data records
In the case of Pipe or CSV Delimited data Newline and carriage return markers /r and or /n are utilized to determine individual data records.
This produces source documents which are utilized one by one by the logic described below. This logic is capable of handling 1-N records, so the same process applies to Data Granularity of Single configured integrations as well as Data Granularity of Batch configured integrations.

Given the 6 different target collections in the Cassandra database (CustomerInformation, CustomerIncidents, CustomerMessages, VehicleInformation, VehicleIncidents, VehicleServiceHistory), which map to configuration entities in the .itrm, data is translated via this process into JSON format for storage in Cassandra. Specifically data is extracted field by field from the source document based on the Associated Field key for each collection (i.e., CustomerInformation).
For XML Documents, common xpath query tools are used to select the right entity.
For JSON Documents, common dotted path query tools such as dot-path are used to select the right entity.
For Fixed Field documents, language level substring methods are used to extract portions of the document based on the starting and ending offsets.
For Comma and Pipe Delimited documents, they are converted to JSON documents and then mapped by ColumnName.
For Binary Documents, the converter is called and run on the document, it is assumed that any configured binary converters will result in a JSON document and they thus are mapped the same as JSON documents.

Once transformation is complete. Data is loaded via the performing Type X Node into Cassandra for OLAP (analytics).

### Example 2—Real Time Online Analytical and Machine Learning Engine

In one embodiment, a platform/system/method of the present application consumes data from the ingress and archive data store (Cassandra), performs analytical calculations and gets answers from machine learning models, both of which are considered trade secrets, and populates it into a transactional DB. The Machine Learning components utilize Cortana Analytics, a Microsoft Corporation product to provide a way to house proprietary machine learning models and operationalize them for use.

This process contains several steps and is continuously running to provide real time processing.

1) Consumption of data from integration framework. This process receives a notification via TCP/IP from the Type Z IFC Node when a data item(s) is/are loaded into the archive/ingress store, and then retrieves the associated data from the store into its local memory.

2) Data from step 1 is sent via HTTPS post to Cortana Analytics for consumption by proprietary machine learning models.

3) Data from step 1 is identified by key identifiers such as “customer identifier” or “vehicle identifier” and additional historical data related to the customer or vehicle is identified in the ingress/archive store based on proprietary heuristics. This data is retrieved from the store and brought into local memory.

4) Data from Step 1 and Step 3 are coalesced and based on proprietary heuristics a current vehicle and customer state is determined.

5) Analytical calculations (extrapolated metrics) are performed on the total data set from Step 4, Step 3 and Step 1.

6) Answers (additional metrics generated based on interpolation rather than extrapolation) from machine learning models are obtained via HTTPS POST/GET from Cortana Analytics.

7) Data points from Step 4 and Step 5 are merged into a single document and populated into the transactional DB.

This process contains several components which are described below. These components reside on multiple nodes in a cluster which make up an Analytical Framework Cluster or AFC. There are 2 node types in the AFC.

Type J Node—This is a singular master node for the AFC Cluster. This node is responsible for managing the workload of calculation nodes. This node is responsible for consuming data availability notifications from a shared message queue from an IFC Type Z Node. This node consumes these notifications, and through a proprietary scheduling algorithm determines an appropriate Type I node to perform action based on this notification. It then creates a job which is a command based on this notification and passes that job to the selected node via a shared message queue.

Type I Node—This is a worker node for the AFC Cluster. This node is responsible for running analytical calculations. This node determines analytics from provided data based on configurable documents known as an Analytical Formula Documents, or .afd. This document is described below and is configured via a technical operator. A single document exists for each analytical calculation that the system performs. These documents are loaded into system local memory upon startup of a Type I Node. Additional proprietary information about vehicles by make model and year including DTC Codes, SPG codes and time estimates, including job families, workhours, and approved warranty work hours, and required resource skillsets, Vehicle Service Recommendations is loaded into memory as well. Device lists are updated from the transactional database tables that contain any information about newly connected telematics devices. Devices are automatically assigned to vehicles by VIN numbers and are used to associate data across the record sets. The entire sum of all analytical calculations that can be performed against an incoming data set are performed programmatically by reading these configuration documents.

These documents have the following required fields:

1) Formula Name—string name of the formula

2) Formula Description—string description of the formula

3) Formula Dependencies—List of dotted path dependencies (i.e., [vehicle.battery_voltage])

4) Formula Outputs—List of outputs provided by this formula, i.e., ([vehicle_battery_low, immediate_service_required)

5) Formula Order—0 based numerical order of the formula.

6) Formula—a proprietary formula is provided based on a proprietary format.

When a Type I Node receives a notification via a shared message queue from a Type J Node it performs the following steps.

1) Retrieve data record(s) indicated by the notification from the Cassandra ingress/archive data store.

2) Analyze the record(s) and using dotted notation path queries, determines customer and vehicle identifiers.

3) Uses the customer and vehicle identifiers from step 2 to query the Cassandra ingress/archive data store and retrieve associated records.

4) Records from Step 1 and 3 are loaded into memory.

5) Create an execution path for analytical calculations by programmatically iterating through all available formulas based on Formula Order. If a formula has dependencies which are not satisfied in the data provided in Step 4 it is not added to the execution path.

6) Analytics are calculated based on the Formula field. The Formula format is mostly proprietary and trade secret and includes a proprietary Domain Specific Language for analytical calculations as well as a syntactically obvious expression pattern that is tokenized and parsed by Abstract Syntax Tree to result in a value. This results in the ability to write expressions as follows:

“output.vehicle_battery_low=convertToBoolean(input.vehicleInformation.battery_voltage<=11.9)”. This expression results in a true value if the incoming battery voltage dictated in the source document is less than or equal to 11.9.

“output.vehicleAlerts.pushAll (input.vehicleIncidents as vehicleIncident {“SPG Code”: mapToSPGCode (vehicleIncident.DTCCode)})”. This expression maps an SPG code for each DTC Code for all vehicle incidents identified in the collection input.vehicleIncidents and pushes them to the vehicleAlerts collection in output.

7) Once all analytics are calculated. New records containing the relevant aggregated information from calculated metrics as well as the source documents from Step 4 are created and stored in the transactional database. These records are now available for consumption in the downstream DSP and Consumer Mobile Application.

8) Once the records are created and stored, an HTTPS POST is made to Cortana Analytics with the newly created records to update learning models, and a subsequent POST is made to ask answers of the models based on the data. These answers provided interpolated insight to the data provided and are stored in the transactional DB for consumption in the downstream DSP and Consumer Mobile Application.

9) Once the records have been created, stored, models have been updated, answers have been stored, then notifications are generated based on the following 3 points:
a) New DTC Code Generated for a vehicle
b) New SPG Code Generated for a vehicle
c) Service Recommendation

Notification data includes identifiers on the customer, the vehicle, the associated service advisor, and any data pertaining to the 3 points mentioned above. These data records are created and are inserted into a transactional collection called “notifications.”

### Example 3—Dealer Service Provider Application

In one embodiment of the present disclosure, a dealer service provider application provides downstream consumption of data from Real Time Analytical and Machine Learning Engine. The data egress from the prior mentioned process is stored in the transactional database.

The dealer service provider application is an application that consumes data from the transactional database and provides services on top of that data in the form of a web site for authorized users. There are 3 main modules to the dealer service provider application. The Opportunity Genie, Shop Genie, and Sales Genie. All 3 modules are contained within the same web site application and their functionality and specific operation is described below.

### 1. Opportunity Genie

1) Module 1—Opportunity Genie
a) Vehicles Dashboard
   I. This dashboard provides a dealer service provider insight into their customers' vehicle health based on the data generated by the Real Time Analytical and Machine Learning Engine. This system is built using NodeJS and RethinkDB with an AngularJS front end. This system is load balanced with NGINX and has support for sticky web socket connections.
   II. A dealer service provider can only see data for vehicles that are serviced at their dealership. Specific service advisors can only see data for customers they directly manage. This is managed through identifying attributes on transactional data for “dealer_id” and “advisor_id.”
   III. Specifically this dashboard provides the following information in a tabulated and modal format to authorized subscribers:
      A) A list of all vehicles and the following information for each vehicle. This data is denormalized and exists in a singular view for performance.
         a. Tabulated data—data available in the list i. The customer associated with that vehicle ii. The vehicle make, model, year, age. iii. Active vehicle alerts—based on section v below.
         b. Modal view data—data that is available via a modal dialog when a vehicle entry in the list is clicked. i. The current status of the vehicle including 1. Battery voltage 2. Fuel Level 3. Engine Temperature 4. Cabin Temperature 5. Miles driven since last update 6. Odometer 7. Altitude ii. Analytics & Machine Learning 1. Oil change due 2. Battery replacement needed 3. Tire change needed 4. New DTC Code a. Recommendation b. Mapped OSG Code c. Cost Estimate d. Time Estimate 5. Regular or scheduled service required based on vehicle age or odometer
   IV. This information is made available in real time by the use of web sockets. When a web client is actively viewing the web site, a web socket connection is maintained with the server and provides change feeds of data as it is updated in the database. Reloading the page is not required to see the latest data. The server utilizes RethinkDB native technology to stream data from collections and interprets the appropriate end consumers of new data based on the following.
      A) When data is updated in the transactional database, the associated records include dealer_ids and advisor_ids. Data is segmented according to these ids and sent to appropriate consumers.
   V. The dashboard component utilizes the following services from the web application
      A) VehicleList—via HTTP GET, this service provides a JSON delimited list of all authorized data points pertaining to 3.a.i above for a service advisor. This provides initial population of the tabular list on the dashboard.
      B) VehicleView—via HTTP GET, this service provides a JSON delimited object of all authorized data points pertaining to 3.a.ii above for a service advisor. This provides population of the modal dialog when clicking on a specific vehicle
      C) ehicleUpdates—via Web Sockets, this service provides a real time change feed to the VehicleList, in the form of JSON delimited objects. This service is built using the publically available NodeJS socket.io module and socket session affinity is provided via socket.io-redis
b) Communicate To Customer
   I. When an entry in the dashboard list is clicked. The dealer service provider has an opportunity to communicate directly with a customer regarding a service need.
      A) There is a button next to each relevant alert that allows a dealer to reach out to a customer about receiving service.
      B) When this button is pressed, the dealer is able to enter a brief 90 character message that can be sent via email, SMS, or mobile push to a customer's mobile application. Customers have the opportunity to respond to text or mobile alerts by calling the dealer or emailing their service advisor.
   II. The communicate to customer component utilizes the following services from the web application
      A) SendCustomerMessage—via HTTP POST, this service accepts a document with the following key data points:
         a. Advisor ID
         b. Incident Code
         c. Estimate
         d. Message (90 characters)
         e. Customer ID
         f. Format—(SMS/email/push)
      When a document is received, this service creates a message based on a predefined format with the incident code, the estimate, the message to the customer and then based on the format, it utilizes email and SMS gateways, mailgun and Red Oxygen respectively to send a message to a customer. The customer's contact information, both mobile number and email id are known data points. Mobile push is handled through Apple Notification Service and Android Push Notifications using Google Cloud Messaging for iOS and Android. These are web service calls that are made with the relevant message to the aforementioned services from this service.
c) Rule based notification settings
   A) There is a separate service called the Notification and Alert Engine or NAE that runs alongside the web applications and consumes data from the transactional database. When that data is consumed alert notifications for significant changes in state or new incidents are automatically generated for the advisor associated with the customer associated with those state changes or new incidents.
      a. This service is a continuously running NodeJS based service which consumes data from a transactional collection called “notifications.” This service periodically checks the table several times a minute for new notifications and then spawns worker processes to process each notification. Spawning of processes is handled using the Child Process module in node and communication between the NAE and worker processes is handled using STDIN and STDOUT.
      b. New notifications are filtered by a state of “new.” Each new record results in a spawned worker process to send the actual notification. These notifications are filtered based on rules defined by the advisor, defined below, and are automatically sent via a standard email template using mailgun. If no rules are defined an advisor receives all notifications. i. Specifically the worker process performs the following for each notification: 1. Get all notification rules for a service advisor 2. For each notification rule, if a rule matches the notification based on a specific DTC code or OSG code and the filter for the rule is Ignore, then do not process. If that code is Send, then always process. 3. Send the notification using a predefined template via mailgun.
   B) The rule based notifications allow a service advisor to filter the notifications which are provided via email, or turn them off entirely.
      a. A service advisor creates a series of “whitelist” or “blacklist” rules that indicate the type of messages they want to receive or do not receive via email. A service advisor clicks on his profile settings via the top right hand menu of the application and selects “Notification Rules.” This results in a tabular view that shows a list of current notification rules and provides functionality through an “Add” button to create additional notification rules. The user also has the ability to delete rules via a “delete” button. When the add button is pressed, a modal dialog pops up and allows the user to enter rules based on the following format. A user will click “Save” when the rule is completed. The same functionality applies to an “edit” button which exists on each row of the tabular view. In the case of an edit button, the modal dialog pops up with data currently entered for the given rule. i. Filter: Choice to select Send/Ignore ii. Customers—Choice to select All or enter specific customer names iii. Alert Type—choice to select different alert types 1. Specific DTC Codes 2. Specific OSG Codes 3. Vehicle Service Recommendations iv. Alerts—field based on Alert Type equal to 1 or 2 that allows entry of specific DTC Codes or OSG Codes in a comma separated list.
   C) The rule based notification component utilizes the following services from the web application.
      a. ListRules i. Service that provides a JSON delimited list of all notification rules in the associated notification rules collection for an advisor in the transactional database.
      b. UpdateOrAddRule—Service that updates or saves a JSON object for an advisor in the associated notification rules collection.
d) Connect a Vehicle
   This component provides the Ability to Scan Vehicle VIN & Ability to Scan OBD2 Device IMEL When a dealer advisor is installing a telematics device in a non-connected vehicle, this facility provides them the ability to connect the vehicle and device to the invention. Via the application menu, a service advisor can select “Connect a Vehicle.” This results in viewing a form on the web site application which allows the service advisor to upload images of the OBD2 devices barcodes and the vehicle VIN barcode. This utilizes the following web application services
   I. ScanCode—Service that receives a binary image from a mobile device via HTTP POST/PUT. This services uses open libraries such as QuaggaJS to scan for a barcode and returns the result.
   II. ConnectDevice—Service that inserts a record into a transactional table called “devices.” The document contains the advisor id, the VIN number, and the IMEI code. Through this collection, this information is made available to the Real Time Online Analytical Processing and Machine Learning system to be tied to a customer and vehicle in the future.

### 2) Module 2—Sales Genie

The Sales Genie allows a vehicle service provider sales associate and service advisor the ability to view the location of their unsold vehicles. Each unsold vehicle has either a telematics device or telematics platform which is connected to this invention's platform.

When a vehicle is sold, it is removed from the Sales Genie and becomes associated with the Opportunity Genie.

This module is accessible through the main navigation menu under “Sales Genie” and specifically provides a map utilizing Google Maps and the Google Maps API which provides the ability to add Pins and Overlays. The map is centered on the dealership location, which is based on LAT/LONG coordinates stored in the transactional database when a dealer is provisioned and associated with the dealer. The map is embedded within the web application and utilizes custom Javascript code to overlay images and icons for vehicles at their specific coordinates as reported through the platform. A dealer sales associate has the ability to filter a vehicle by VIN number and show the last reported location in the platform of that vehicle.

The map utilizes the following services from the web application.

a) ListOwnedVehicles—via HTTP GET, this service provides a list of unsold vehicles which are owned by the dealer with the following key pieces of data, VIN number, Lat, Long. This is then consumed by the front end javascript code to overlay images and icons for vehicles in accordance with the Google Maps API. If the query parameter serviceLoaners is sent with a value of true, then service loaner vehicles will be provided by this service instead of unsold vehicles

### 3) Module 3—Scheduling Genie

This module is accessible through the main navigation menu under “Scheduling Genie” and specifically provides the ability to “Schedule a Vehicle” for Service and “Respond to Pending Service Requests”

The Respond to Pending Service Requests component presents a service advisor with a tabulated list of service requests from customers. A service advisor can click on a service request and based on text input message description of the problem provided by the customer, select relevant SPG codes in the UI or they manually enter a time estimate for the service and then click “Schedule.” Once they click “Schedule” the ScheduleGenieService automatically takes this estimate and matches it to shop availability and required resource skill availability to return a list of matching times. The service advisor is then taken to the Schedule a Vehicle component with the matching times based on resource load and service lane availability highlighted in yellow on the calendar. Once the service advisor clicks on a yellow block, he or she can schedule that service request.

The Schedule a Vehicle component presents a service advisor with a calendar view for daily and weekly dates.
Each day is horizontally divided up by the number of service lanes that the shop has available and displays availability based on those service lanes via color coded blocks. Light blue indicates scheduled service, white indicates no service scheduled.
Time is expressed vertically in the calendar view
A service advisor can click on a light blue color coded block and view/edit the time associated with the scheduled service
A service advisor can click on a white color coded block and create a scheduled service by selecting the vehicle and its subsequent incidents.
A service advisor can intelligently schedule service by clicking the “Genie” button which allows them to select the specific vehicle to schedule and it's incidents to be addressed. Based on the Real Time Analytics and Machine Learning engine, time estimates based on SPG codes, job families, and work hours are already associated to each incident, and can be summated to provide an overall service time estimate and subsequently match that estimate to shop availability. The ScheduleGenieService takes this estimate and matches it to shop availability and required resource skill availability to return a list of matching times. This information is graphically overlayed on the calendar to provide ease of use in finding a matching time slot.
   Once a service advisor uses the Genie, available shop times and service lanes in the calendar are overlayed in light yellow to indicate they match the time required. The service advisor can click on these light yellow blocks and schedule that vehicle for service.
When a vehicle is scheduled for service through this method, any associated Service are automatically marked as resolved.
When a vehicle is scheduled for service, the customer is automatically notified via email of the scheduled date and time of the service and time estimate for completion.
   4) Sub-Module/Additive Feature—View Service Loaner Vehicles on Local Map—this component utilizes the same underlying technology and functionality as the Sales Genie, but instead allows a service advisor to see the location of service loaner vehicles instead of on a local map.

### Example 4—Consumer Mobile Application

This is a mobile application built with two downstream targets, iOS and Android. This allows a customer to view the state of their vehicle if their vehicle is connected to this invention's platform. There are two main features of this application.

a) VehicleCheck Dashboard
(i) View Active Alerts for Vehicle
   A dashboard of icons of respective vehicle alerts that are present for this vehicle. Includes items such as oil change due, service required, new DTC code. When pressed, these icons provide a view which displays an explanation of the alert, a potential cost associated with service for this alert, the priority of the alert (Severe, High, Medium, Low), and the ability to Request Vehicle Service based on this alert. The potential out of pocket cost is calculated from a web service exposed by the Dealer Service Provider application that estimates cost based on parts lists, labor hours, and warranty coverage.

b) Request Vehicle Service
This provides a customer who is a mobile user the ability to request vehicle service from their dealer service provider for their vehicle either independent of an alert or based on an alert. This can be accessed from the detail view on an alert or independently through the application menu.
(i) Related to—allows a customer to enter free form text or select specific active alerts that he or she requests service on.
   A) If a customer fills this in, it this produces an automatic time estimate from a web service exposed by the Dealer Service Provider web application for the SchedulingGenie, which calculates the estimate based on the associated SPG codes, job families, and the associated work hours to those codes. This time estimate is displayed to the customer for reference.
(ii) Select a day and time
   A) If the customer's related to field resulted in a time estimate this field is shown.
   B) This field allows a customer to select a day and a time for their service based on the shop availability and the time estimate for service. A list of relevant available days and times is generated from the server based on both the time estimate and the required resource skillsets for those services. A customer selects a time and day that matches his or her
(iii) Schedule Request—If the customer entered free form text then the system was unable to calculate a time estimate and cannot provide automatic scheduling. Customer selects one of the following:
   A) Request Specific Dates
      a) Allows a customer to request service on up to 3 specific dates.
   B) Request Specific Days of week
      a) Allows a customer to request service on specific days of the week.
   C) Request Specific Times
      a) Allows a customer to request service at specific times in any day.
   The customer presses Submit and the request document is captured in the transactional database of the Dealer Service Provider web application via web services.
   If the customer was able to automatically schedule their service, their date is confirmed, visible within the Dealer Service Provider web application and the customer automatically receives an email of their confirmation.
   If the customer was not able to automatically schedule their service (because they did not specify issues to address) then that service schedule request is now available for view under “Respond to Pending Service Requests” within the Dealer Service Provider Application.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented system comprising: a digital processing device comprising: at least one processor, an operating system configured to perform executable instructions, a memory, and a computer program including instructions executable by the digital processing device to create a vehicle health and information application comprising:
a) a software module performing ingress and aggregation of vehicle data for a plurality of vehicles and storing the vehicle data in a central storage, the vehicle data originated, at least in part, from vehicle telematics systems;
b) a software module predicting future vehicle events by application of one or more machine learning models to the vehicle data; and
c) a software module providing a dealership vehicle health and information portal comprising:
i) a dashboard presenting current vehicle system state for each vehicle in the plurality of vehicles and vehicle event history for each vehicle in the plurality of vehicles,
ii) an opportunity genie presenting predicted future vehicle events for each vehicle in the plurality of vehicles and cost estimates for performing currently needed and predicted repairs, and
iii) a notification rule engine allowing a dealership user to define rules for customized, automated consumer notifications, wherein each rule comprises a triggering vehicle event and a message.

2. The system of claim 1, wherein the vehicle data comprises event-based vehicle information.

3. The system of claim 2, wherein the event-based vehicle information comprises diagnostic trouble codes (DTCs).

4. The system of claim 1, wherein the vehicle data comprises time-based vehicle information.

5. The system of claim 4, wherein the time-based vehicle information comprises vehicle location coordinates, vehicle altitude, vehicle battery voltage, vehicle fuel level, vehicle oil level, vehicle tire pressure, vehicle speed, vehicle acceleration, vehicle braking, vehicle odometer reading, or a combination thereof.

6. The system of claim 1, wherein the vehicle data comprises wireless assistance service (WAS) system data.

7. The system of claim 6, wherein the wireless assistance service (WAS) system data comprises requests for assistance.

8. The system of claim 1, wherein the vehicle data comprises customer relationship management (CRM) system data.

9. The system of claim 8, wherein the customer relationship management (CRM) system data comprises services performed on the vehicle, consumer inquires pertaining to the vehicle, consumer dealer visits pertaining to the vehicle, consumer personal data, or a combination thereof.

10. The system of claim 1, wherein the message is based on a stored notification template.

11. The system of claim 1, wherein the application further comprises a software module transmitting the notifications via SMS, IM, social media post, microblog post, email, or mobile push when a triggering event is detected.

12. The system of claim 1, wherein the current vehicle system state comprises location, altitude, direction, engine temperature, cabin temperature, speed, acceleration, braking, odometer reading, or a combination thereof.

13. The system of claim 1, wherein the vehicle event history comprises vehicle service performed, vehicle service requested, vehicle service previously predicted, DTCs transmitted, WAS requests for assistance, or a combination thereof.

14. The system of claim 1, wherein the dealership vehicle health and information portal further comprises a software module providing a sales genie allowing the dealership user to search a vehicle inventory and locate a particular vehicle on a map.

15. The system of claim 1, wherein the dealership vehicle health and information portal further comprises a software module providing a shop genie allowing the dealership user to schedule service and locate service vehicles on a map.

16. The system of claim 1, further comprising a mobile digital processing device comprising: at least one processor, an operating system configured to perform executable instructions, a memory, and a mobile application including instructions executable by the mobile digital processing device to create a vehicle owner mobile application.

17. The system of claim 16, wherein the vehicle owner mobile application comprises a software module presenting an interface allowing the vehicle owner to request vehicle service.

18. Non-transitory computer-readable storage media encoded with a computer program including instructions executable by a processor to create a vehicle health and information application comprising:
a) a software module performing ingress and aggregation of vehicle data for a plurality of vehicles and storing the vehicle data in a central storage, the vehicle data originated, at least in part, from vehicle telematics systems;
b) a software module predicting future vehicle events by application of one or more machine learning models to the vehicle data; and
c) a software module providing a dealership vehicle health and information portal comprising:
i) a dashboard presenting current vehicle system state for each vehicle in the plurality of vehicles and vehicle event history for each vehicle in the plurality of vehicles,
ii) an opportunity genie presenting predicted future vehicle events for each vehicle in the plurality of vehicles and cost estimates for performing currently needed and predicted repairs, and
iii) a notification rule engine allowing a dealership user to define rules for customized, automated consumer notifications, wherein each rule comprises a triggering vehicle event and a message.

19. The media of claim 18, wherein the vehicle data comprises event-based vehicle information.

20. The media of claim 19, wherein the event-based vehicle information comprises diagnostic trouble codes (DTCs).

21. The media of claim 18, wherein the vehicle data comprises time-based vehicle information.

22. The media of claim 21, wherein the time-based vehicle information comprises vehicle location coordinates, vehicle altitude, vehicle battery voltage, vehicle fuel level, vehicle oil level, vehicle tire pressure, vehicle speed, vehicle acceleration, vehicle braking, vehicle odometer reading, or a combination thereof.

23. The media of claim 18, wherein the vehicle data comprises wireless assistance service (WAS) system data.

24. The media of claim 23, wherein the wireless assistance service (WAS) system data comprises requests for assistance.

25. The media of claim 18, wherein the vehicle data comprises customer relationship management (CRM) system data.

26. The media of claim 25, wherein the customer relationship management (CRM) system data comprises services performed on the vehicle, consumer inquires pertaining to the vehicle, consumer dealer visits pertaining to the vehicle, consumer personal data, or a combination thereof.

27. The media of claim 18, wherein the message is based on a stored notification template.

28. The media of claim 18, wherein the application further comprises a software module transmitting the notifications via SMS, IM, social media post, microblog post, email, or mobile push when a triggering event is detected.

29. The media of claim 18, wherein the current vehicle system state comprises location, altitude, direction, engine temperature, cabin temperature, speed, acceleration, braking, odometer reading, or a combination thereof.

30. The media of claim 18, wherein the vehicle event history comprises vehicle service performed, vehicle service requested, vehicle service previously predicted, DTCs transmitted, WAS requests for assistance, or a combination thereof.

31. The media of claim 18, wherein the dealership vehicle health and information portal further comprises a software module providing a sales genie allowing the dealership user to search a vehicle inventory and locate a particular vehicle on a map.

32. The media of claim 18, wherein the dealership vehicle health and information portal further comprises a software module providing a shop genie allowing the dealership user to schedule service and locate service vehicles on a map.

33. A computer-implemented method of managing vehicle health information to generate opportunity for dealerships comprising:
a) performing, at a computer, ingress and aggregation of vehicle data for a plurality of vehicles and storing the vehicle data in a central storage, the vehicle data originated, at least in part, from vehicle telematics systems;
b) predicting, at the computer, future vehicle events by application of one or more machine learning models to the vehicle data; and
c) providing, by the computer, a dealership vehicle health and information portal comprising:
iv) a dashboard presenting current vehicle system state for each vehicle in the plurality of vehicles and vehicle event history for each vehicle in the plurality of vehicles,
v) an opportunity genie presenting predicted future vehicle events for each vehicle in the plurality of vehicles and cost estimates for performing currently needed and predicted repairs, and
vi) a notification rule engine allowing a dealership user to define rules for customized, automated consumer notifications, wherein each rule comprises a triggering vehicle event and a message.

34. The method of claim 33, wherein the vehicle data comprises event-based vehicle information.

35. The method of claim 34, wherein the event-based vehicle information comprises diagnostic trouble codes (DTCs).

36. The method of claim 33, wherein the vehicle data comprises time-based vehicle information.

37. The method of claim 36, wherein the time-based vehicle information comprises vehicle location coordinates, vehicle altitude, vehicle battery voltage, vehicle fuel level, vehicle oil level, vehicle tire pressure, vehicle speed, vehicle acceleration, vehicle braking, vehicle odometer reading, or a combination thereof.

38. The method of claim 33, wherein the vehicle data comprises wireless assistance service (WAS) system data.

39. The method of claim 38, wherein the wireless assistance service (WAS) system data comprises requests for assistance.

40. The method of claim 33, wherein the vehicle data comprises customer relationship management (CRM) system data.

41. The method of claim 40, wherein the customer relationship management (CRM) system data comprises services performed on the vehicle, consumer inquires pertaining to the vehicle, consumer dealer visits pertaining to the vehicle, consumer personal data, or a combination thereof.

42. The method of claim 33, wherein the message is based on a stored notification template.

43. The method of claim 33, wherein the method further comprises transmitting, by the computer, the notifications via SMS, IM, social media post, microblog post, email, or mobile push when a triggering event is detected.

44. The method of claim 33, wherein the current vehicle system state comprises location, altitude, direction, engine temperature, cabin temperature, speed, acceleration, braking, odometer reading, or a combination thereof.

45. The method of claim 33, wherein the vehicle event history comprises vehicle service performed, vehicle service requested, vehicle service previously predicted, DTCs transmitted, WAS requests for assistance, or a combination thereof.

46. The method of claim 33, wherein the dealership vehicle health and information portal further comprises a sales genie allowing the dealership user to search a vehicle inventory and locate a particular vehicle on a map.

47. The method of claim 33, wherein the dealership vehicle health and information portal further comprises a shop genie allowing the dealership user to schedule service and locate service vehicles on a map.
